(19) United States
(12) Patent Application Publication
(10) Pub. No.: US 2012/0141134 A1
(43) Pub. Date: Jun. 7, 2012

(54) TRANSPONDER FOR AN OPTICAL COMMUNICATIONS SYSTEM AND OPTICAL COMMUNICATIONS SYSTEM

(76) Inventor: Fabian Nikolaus HAUSKE, Munich (DE)

(21) Appl. No.: 13/370,804

(22) Filed: Feb. 10, 2012

Related U.S. Application Data
(63) Continuation of application No. PCT/CN2010/075152, filed on Jul. 14, 2010.

(51) Int. Cl. H04B 10/00

(52) U.S. Cl. 398/135

(57) ABSTRACT

A transponder is adapted to communicate with a further transponder over at least one optical channel. The transponder comprises a first receiver having a monitor and a first transmitter. The first receiver is configured to receive a first signal transmitted by a second transmitter of the further transponder over the optical channel. The monitor is configured to provide at least one channel parameter describing the optical channel in dependence on the received first signal. The first transmitter is configured to transmit the at least one channel parameter to the further transponder for adjusting a pre-equalizer of the further transponder.

### CROSS-REFERENCE TO RELATED APPLICATION

This application is a continuation of International Application No. PCT/CN2010/0751522, filed on Jul. 14, 2010, entitled “Transponder for an optical communications system and optical communications system,” which is hereby incorporated herein by reference.

### BACKGROUND OF THE INVENTION

The present invention relates to communications over optical communications systems having at least one optical channel.

Conventional transponders for optical communication include a transmitter and a receiver in one device. Especially in long-haul transmission, two transponders define a bidirectional link, wherein the data is transmitted between the transmitter and the receiver in the respective device. The two optical paths or channels of the bidirectional link do not necessarily need to be in the same wavelength or the same path.

Further to meet demands for transmission capacity, the spectral efficiency has to be increased with higher-order modulation formats like QPSK, 16 QAM or even higher signal constellations. It may be clear that higher-order modulation formats may be more sensitive to linear and non-linear channel distortions.

For equalizing and recovering transmitted data, digital signal processing (DSP) in coherent receivers are applied to compensate or mitigate the linear and non-linear channel distortions. Given the high data rates, it may be challenging to implement a high-speed ASIC for 100 Gbit/s PDM-QPSK transmission. Higher-order modulation formats like 16 QAM may require even more complexity, such that digital equalization in the receiver may not be realized yet.

Therefore, a part of the digital equalization may be placed in the transmitter. Such a method, known as pre-equalization or pre-distortion, allows compensating for linear and non-linear channel distortions. A similar transmitter-based pre-processing may be required for modulation formats like OFDM.

Moreover, conventional transponders only transmit information in one direction such that the transmitter does not have information from the receiver. The receiver conventionally employs comprehensive digital signal processing in order to compensate for channel distortions and to recover the transmitted information.

Methods for predistortion or pre-processing a signal to be transmitted from one transponder to another transponder over an optical channel in order to compensate for linear and non-linear channel impairments are known from references [1] to [3].

In reference [1], electronic dispersion compensation by signal predistortion is described using digital processing and a dual-drive Mach-Zehnder modulator.

In reference [2], a method for reducing memory requirements for electrical compensation of intra-channel non-linearity in an optical communications system is shown. Therein, a digital filter is provided for processing an electrical input signal to be conveyed through an optical communications system. A processing generates a predistorted electrical signal using a compensation function that substantially mitigates for intra-channel non-linearity imparted to the communications signal by the optical communications system. The digital filter has a memory having a limited size storing a reduced status set used for approximating an original, unreduced data set used to implement the compensation function. The reduced data set is used for the digital filter to apply the compensation function to mitigate the intra-channel non-linearity over longer transmission distances of the optical communications system than would be possible without the use of the reduced data set.

In reference [3], an electrical domain compensation of optical dispersion in an optical communications system is described. Therein, optical dispersion imposed on a communications signal conveyed through an optical communications system is compensated by modulating the communications signal in the electrical domain. A compensation function is determined that substantially mitigates the chromatic dispersion (CD). The communications signal is then modulated in the electrical domain using the compensation function. The electrical domain compensation can be implemented in either the transmitter or the receiver end of the communications system. The compensation is particularly implemented in the transmitter, using a look-up table and a digital-to-analog converter to generate an electrical predistorted signal. The electrical predistorted signal is then used to modulate an optical source to generate a corresponding predistorted optical signal for transmission through the optical communications system.

In reference [4], various methods for monitoring optical channel parameters for optical performance monitoring are described. In particular, methods to estimate channel parameters in a digital processing structure subsequent to an optical coherent demodulation and analogue-to-digital conversion are shown.

### SUMMARY OF THE INVENTION

One of the goals of the present disclosure is to provide a control or an adjustment of a transponder of an optical communications system by using feedback channel parameters describing the optical channel used by the transponder communicating towards a further transponder.

According to some implementations, a feedback channel is provided allowing communication between the receiver of a first transponder and the transmitter of a second transponder of a point-to-point transmission link in the optical communications system. In particular, the feedback channel may be defined in a physical layer.

The feedback information channel may be employed to jointly optimize the parameter settings of the transmitter and the receiver, which may lead to a global optimization of the point-to-point transmission link.

According to some implementations, an adaptive adjustment of the pre-equalizer or predistortion means of the transponder is used with respect to time-varying channel distortions of the optical channel.

According to some implementations, a receiver-based monitoring function with a physical layer feedback channel is used.

According to some implementations, full compensation of chromatic distortion may be achieved as well as compensation of intra-channel non-linearities. Even time-varying polarization effects like rotation of the states of polarization and polarization-mode dispersion may be compensated.

According to some implementations, device imperfection like transmitter side skew, I/Q-imbalance, DC offset, X/Y-skew or X/Y-imbalance may be addressed with essential compensation. The same applies similarly to receiver side device imperfections.

According to a first aspect, a transponder for an optical communications system is suggested, the transponder called first transponder in the following. The first transponder is adapted to communicate with a second transponder over at least one optical channel. The first transponder comprises a first receiver having a monitor and a first transmitter. The first receiver is configured to receive a first signal transmitted by a second transmitter of the second transponder over the optical channel. The monitor is configured to provide at least one first channel parameter describing the optical channel in dependence on the received first signal. The first transmitter is configured to transmit the at least one channel parameter to the second transponder for adjusting a pre-equalizer of the second transponder.

The respective transponder may be embodied in one line card.

The respective receiver may be any receiving means. Furthermore, the respective transmitter or sender may be any transmitting means. Moreover, the respective monitor may be any monitoring means.

The respective means, in particular the receiver, the transmitter and the monitor, may be implemented in hardware or in software. If the means are implemented in hardware, it may be embodied as a device, e.g. as a computer or as a processor or as a part of a system. If the means are implemented in software, it may be embodied as a computer program product, as a function, as a routine, as a program code or as an executable object.

According to a first implementation form of the first aspect, the first transmitter has a first pre-equalizer for pre-equalizing a second signal to be transmitted to the second receiver of the second transponder, the second signal including the at least one first channel parameter.

According to a second implementation form of the first aspect, the first transmitter has a first pre-equalizer for pre-equalizing a second signal to be transmitted to a second receiver of the second transponder over a second optical channel. The second signal may include the at least one first channel parameter. The first transponder further has a first adjuster being configured to adjust the first pre-equalizer dependent on at least one second channel parameter generated in dependence on the second signal as received by the second receiver.

According to a third implementation form of the first aspect, the first transponder has a first pre-equalizer for pre-equalizing a second signal to be transmitted to a second receiver of the further transponder over a second optical channel. The second signal may include at least one channel parameter. The transponder may have a first adjuster being configured to adjust the first pre-equalizer dependent on at least one second channel parameter being generated in dependence on the second signal as received by the second receiver. The first adjuster may be configured to adjust at least one drive voltage, certain transmitter component parameters, a polarization orientation, a puls-shaping, a signal modulation and/or filter coefficients for pre-equalization.

According to a fourth implementation form of the first aspect, the first transmitter may be configured to transmit the at least one first channel parameter in a physical layer to the second transponder.

According to a fifth implementation form of the first aspect, the first transmitter has a first pre-equalizer for pre-equalizing a second signal to be transmitted to a second receiver of the second transponder, the second signal including the at least one first channel parameter, wherein the first signal and the second signal are transmitted over a first optical channel and the second signal is transmitted over a second optical channel, wherein the first and second optical channels are provided by one single optical fiber.

According to a sixth implementation form of the first aspect, the first transmitter has a first pre-equalizer for pre-equalizing a second signal to be transmitted to a second receiver of the second transponder, the second signal including the at least one first channel parameter, wherein the first signal and the second signal are transmitted over a first optical channel and the second signal is transmitted over a second optical channel, wherein the first and second of optical channels are provided by two different optical fibers.

According to a seventh implementation form of the first aspect, the first transponder may have a multiplexer being configured to multiplex the at least one first channel parameter and first consumer data to be transmitted as the second signal over a second optical channel. In particular, the multiplexer may add binary information data representing the at least one channel parameter to the first communication data. Furthermore, the binary information may represent different training data or any other encoded information. Thus, the respective slot at the optical channel reserved for transmitting the at least one channel parameter may be used differently in different phases, training phases and operating phases.

According to an eighth implementation form of the first aspect, the first transponder may further comprise an encoder and a multiplexer, the encoder being configured to encode the at least one first channel parameter for providing at least one encoded first channel parameter, and the second multiplexer being configured to multiplex the at least one encoded first channel parameter and first customer data to be transmitted as the second signal over a second optical channel. Particularly, the transponder may have a decoder for decoding demultiplexed encoded channel parameters.

According to a ninth implementation form of the first aspect, the first transponder further has a multiplexer being configured to multiplex the at least one first channel parameter such that is transmitted over at least one slot of a second optical channel in an operating phase, wherein the at least one slot may be re-used for transmitting training data in a training phase.

According to a tenth implementation form of the first aspect, the first transponder further has a de-multiplexer being configured to demultiplex the at least one multiplexed first channel parameter. Thus, the de-multiplexer may receive the second signal and separate the at least one encoded first channel parameter and the first customer data.

According to a eleventh implementation form of the first aspect, the optical channel may be embodied by a long-haul optical transmission link, in particular by an ultra-long-haul high-capacity optical transmission link.

In particular, the pair of transponders may be connected with the bidirectional channel. The paths of each data stream may be equal or different.

According to a second aspect, a transponder for an optical communications system is suggested, the transponder comprising a first transmitter, a first receiver and an adjuster. The first transmitter may be configured to transmit a first signal to a second receiver of a second transponder over an optical channel, the first transmitter having a pre-equalizer for pre-equalizing the first signal. The first receiver may be configured to receive a second signal transmitted by a second transmitter of the second transponder, the second signal including at least one channel parameter describing the optical channel and generated in dependence on the first signal. The adjuster may be configured to adjust the pre-equalizer in dependence on the received at least one channel parameter.

According to a third aspect, an optical communications system is suggested comprising at least two transponders as described above and at least one optical channel coupling the transponders.

According to a fourth aspect, a method for adjusting a pre-equalizer in an optical communications system is suggested, the method comprising the following steps:

receiving a first signal at a first transponder, the first signal being transmitted over a first optical channel by a second transponder,
providing at least one channel parameter describing the first optical channel in dependence on the received first signal of the first transponder,
transmitting the provided at least one channel parameter to the second transponder, and
adjusting the pre-equalizer of the second transponder in dependence on the transmitted at least one channel parameter.

According to some implementations, a physical layer feedback control channel for bidirectional optical transmission is provided.

According to some implementations, a feedback path from the receiver of a first transponder to the transmitter of a second transponder is provided in order to exchange information about signal parameters and the signal quality. A monitoring function or block may extract signal information at the receiver. This extracted signal information may be encoded and transmitted back to the receiver. In particular, the encoded signal information may be multiplexed onto the data stream of the reverse transmitter which may be placed within the same transponder. At the transmitter, this information may be demultiplexed and decoded such that the monitored signal information from the receiver may be available at the transmitter. In particular, a feedback channel for this information transfer from the receiver to the transmitter may be provided in the optical communications system.

According to some implementations, the transmission performance may be highly improved by optimizing the transmitter, in particular its pre-equalizer.

According to some implementations, the customer or client may be only hardly affected, as the increase in line rate may be negligible in the range of a few percent. Further, the architecture of adding such information may be mature.

According to some implementations, a monitor or monitoring means at the receiver of the respective transponder can be provided in order to evaluate the quality of the received signal, estimate channel parameters or provide control parameters.

According to some implementations, a demultiplexer or demultiplexing means may be provided to extract the binary feedback information in order to provide optimum parameter settings and/or pre-equalization.

According to some implementations, a continuous feedback and updating means may be provided in order to provide adaptive tracking or time-varying impairments.

### BRIEF DESCRIPTION OF THE DRAWINGS

Further embodiments of the invention will be described with respect to the following figures in which:

FIG. 1 shows a first embodiment of a transponder for an optical communications system;

FIG. 2 shows an embodiment of an optical communications system;

FIG. 3 shows a second embodiment of a transponder for an optical communications system; and,

FIG. 4 shows an embodiment of a method for adjusting a pre-equalizer in an optical communication.

### DETAILED DESCRIPTION OF EMBODIMENTS OF THE INVENTION

In FIG. 1, a first embodiment of a transponder 101 of an optical communications system is shown. The transponder 101 may be called first transponder in the following. The first transponder 101 has a first receiver 103 having a monitor 105 and a first transmitter 107.

The first receiver 103 is adapted to receive a first signal S1. The first signal S1 is transmitted by a second transmitter of a further transponder over an optical channel 109.

The monitor 105 is adapted to provide at least one channel parameter CP1 describing the optical channel 109 in dependence on the received first signal S1.

Further, the first transmitter 107 is adapted to transmit the at least one first channel parameter CP1 to the further transponder for adjusting the pre-equalizer of the further transponder.

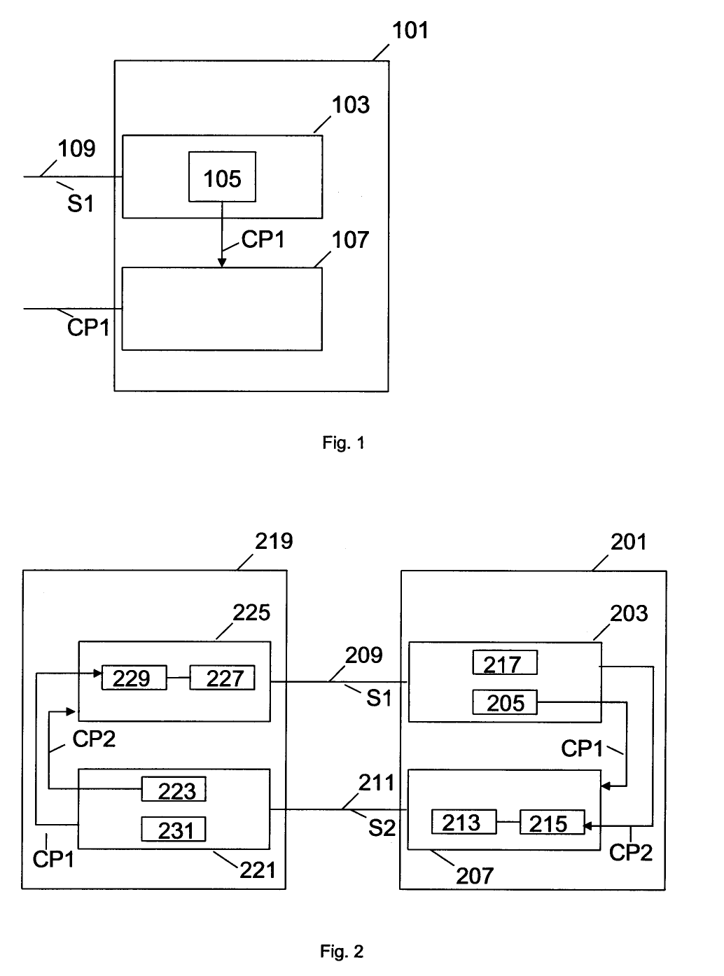

In FIG. 2, an embodiment of an optical communications system is depicted. The optical communications system has a first transponder 201 which is exemplarily embodied as the transponder 101 of FIG. 1. The first transponder 201 has a first receiver 203 with a monitor 205 and a first transmitter 207.

The optical communications system further has a first optical channel 209 and a second optical channel 211. The first and second optical channels 209, 211 may be provided by one single optical fiber or by two different optical fibers. In particular, the optical channels 209, 211 may be embodied by a long-haul optical transmission link.

Furthermore, the first transponder 201 has a first pre-equalizer 213, a first adjuster 215 and a first post-equalizer 217.

The first transponder 201 is coupled towards a second transponder 219 by means of the first and second optical channels 209 and 211. The second transponder 219 may have an analogous architecture as the first transponder 201.

In this regard, the second transponder 219 has a second receiver 221, a second monitor 223, a second transmitter 225, a second pre-equalizer 227, a second adjuster 229 and a second post-equalizer 231.

The respective receiver 203, 221 is configured to receive a signal S1, S2 transmitted by the transmitter 207, 225 of the respective other transponder 201, 219 over one of the optical channels 209, 211.

The respective monitor 205, 223 is configured to provide channel parameters CP1, CP2 describing the respective optical channel 209, 211 in dependence on the respective received signal S1, S2.

The respective transmitter 207, 225 is configured to transmit the channel parameters CP1, CP2 to the respective other transponder 207, 225 for adjusting the pre-equalizer 217, 227 of the other transponder 201, 219.

The respective adjuster 215, 229 is configured to adjust the respective pre-equalizer 213, 227 dependent on the channel parameters CP1, CP2 received from the respective other transponder 201, 219.

In particular, the respective adjuster 215, 229 may be adapted to adjust at least one drive voltage, certain component parameters, polarization orientation, a puls-shaping, a signal modulation and/or filter coefficients for pre-equalization.

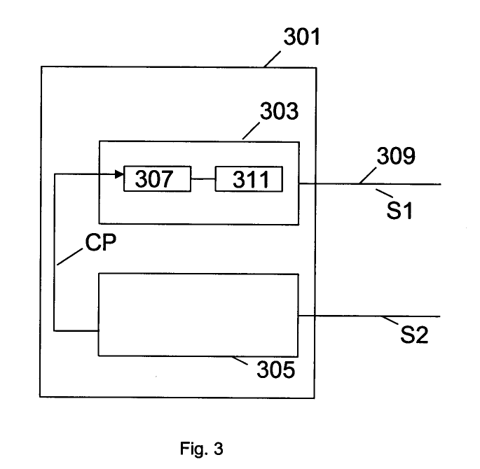

FIG. 3 shows a second embodiment of a transponder 301 for an optical communications system. The transponder 301, in the following also called first transponder 301, has a first transmitter 303, a first receiver 305 and an adjuster 307.

The first transmitter 303 is adapted to transmit a first signal S1 to a second receiver of a second transponder over an optical channel 309. The first transmitter 303 may have a pre-equalizer 311 for pre-equalizing the first signal S1.

The first receiver 305 may be adapted to receive a second signal S2 transmitted by a second transmitter of the second transponder. The second signal S2 may include at least one channel parameter CP describing the optical channel 309 and being generated in dependence on the first signal S1. Further, the adjuster 307 may be adapted to adjust the pre-equalizer 311 in dependence on the received at least one channel parameter CP.

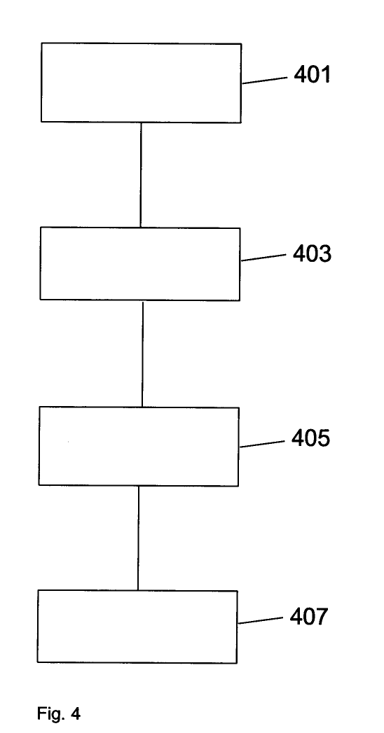

FIG. 4 illustrates an embodiment of a method for adjusting a pre-equalizer in an optical communications system having at least a first transponder and a second transponder. The method of FIG. 4 has the steps 401 to 407.

In the step 401, a first signal is received at the first transponder. The first signal has been transmitted over a first optical channel by the second transponder.

In the step 403, at least one channel parameter is provided, the at least one channel parameter describing the first optical channel. Further, the at least one channel parameter may be provided in dependence on the received first signal at the first transponder.

In the step 405, the provided at least one channel parameter is transmitted to the second transponder.

In the step 407, the pre-equalizer of the second transponder is adjusted in dependence on the transmitted at least one channel parameter.

It will be apparent to those skilled in the art that various modifications and variations can be made in the disclosed embodiments without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### REFERENCES

[1] R. I. Killey, P. M. Watts, V. Mikhailov, M. Glick, and P. Bayvel, “Electronic dispersion compensation by signal predistortion using digital processing and a dual-drive Mach-Zehnder modulator”, OFC, 2005
[2] US 2010/0046958 A1
[3] U.S. Pat. No. 7,382,984 B2
[4] Calvin C. K. Chan (Editor), “Optical Performance Monitoring, Advanced Techniques for Next-Generation Photonic Networks”, Elesevier (2010)

1. A transponder for an optical communications system, comprising a first receiver having a monitor and a first transmitter,
the first receiver being configured to receive a first signal transmitted by a second transmitter of a further transponder over an optical channel,
the monitor being configured to provide at least one first channel parameter describing the optical channel in dependence on the received first signal, and
the first transmitter being configured to transmit the at least one first channel parameter to the further transponder for adjusting a pre-equalizer of the further transponder.

2. The transponder of claim 1, wherein the first transmitter has a first pre-equalizer for pre-equalizing a second signal to be transmitted to a second receiver of the further transponder, the second signal including the at least one first channel parameter.

3. The transponder of claim 1, wherein the first transponder has a first pre-equalizer for pre-equalizing a second signal to be transmitted to a second receiver of the further transponder over a second optical channel, the second signal including at least one first channel parameter, wherein the transponder has a first adjuster being configured to adjust the first pre-equalizer dependent on at least one second channel parameter generated in dependence on the second signal as received by the second receiver.

4. The transponder of claim 1, wherein the first transponder has a first pre-equalizer for pre-equalizing a second signal to be transmitted to a second receiver of the further transponder over a second optical channel, the second signal including at least one channel parameter, wherein the transponder has a first adjuster being configured to adjust the first pre-equalizer dependent on at least one second channel parameter generated in dependence on the second signal as received by the second receiver, wherein the first adjuster is configured to adjust at least one drive voltage, certain transmitter component parameters, a polarization orientation, a puls-shaping, a signal modulation and/or filter coefficients for pre-equalization.

5. The transponder of claim 1, wherein the first transmitter is configured to transmit the at least one first channel parameter in a physical layer to the further transponder.

6. The transponder of claim 1, wherein the first transmitter has a first pre-equalizer for pre-equalizing a second signal to be transmitted to a second receiver of the further transponder, the second signal including the at least one first channel parameter, wherein the first signal is transmitted over the first optical channel and the second signal is transmitted over a second optical channel, the first and second optical channels being provided by one single optical fiber.

7. The transponder of claim 1, wherein the first transmitter has a first pre-equalizer for pre-equalizing a second signal to be transmitted to a second receiver of the further transponder, the second signal including the at least one first channel parameter, wherein the first signal is transmitted over the first optical channel and the second signal is transmitted over a second optical channel, the first and second optical channels being provided by two different optical fibers.

8. The transponder of claim 1, further comprising a multiplexer being configured to multiplex the at least one first channel parameter and first customer data to be transmitted as the second signal over a second optical channel.

9. The transponder of claim 1, further comprising an encoder and a multiplexer, the encoder being configured to encode the at least one first channel parameter for providing at least one encoded first channel parameter, and the multiplexer being configured to multiplex the at least one encoded first channel parameter and first customer data to be transmitted as the second signal over a second optical channel.

10. The transponder of claim 1, further comprising a multiplexer being configured to multiplex at least one first channel parameter such that it is transmitted over at least one slot of a second optical channel in an operating phase, wherein the at least one slot is re-used for transmitting training data in a training phase.

11. The transponder of claim 1, wherein the optical channel is embodied by a long-haul optical transmission link, in particular by an ultra-long-haul high-capacity optical transmission link.

12. A transponder for an optical communications system, comprising a first transmitter, a first transceiver and an adjuster,
the first transmitter being configured to transmit a first signal to a second receiver of a further transponder over an optical channel, the first transmitter having a pre-equalizer for pre-equalizing the first signal,
the first receiver being adapted to receive a second signal transmitted by a second transmitter of the further transponder, the second signal including at least one channel parameter describing the optical channel and being generated in dependence on the first signal, and
the adjuster being configured to adjust the pre-equalizer in dependence on the received at least one channel parameter.

13. An optical communications system, comprising:
a first transponder
a second transponder, and
at least one optical channel coupling the first transponder and the second transponder.

14. An optical communications system, comprising. two transponders, each transponder being embodied as a transponder of claim 1, and
at least one optical channel coupling the two transponders.

15. A method for adjusting a pre-equalizer in an optical communications system, comprising:
receiving a first signal at a first transponder, the first signal being transmitted over a first optical channel by a second transponder,
providing at least one channel parameter describing the first optical channel in dependence on the received first signal of the first transponder,
transmitting the provided at least one channel parameter to the second transponder, and
adjusting the pre-equalizer of the second transponder in dependence on the transmitted at least one channel parameter.
